(19) United States
(12) Patent Application Publication
(10) Pub. No.: US 2016/0241783 A1
(43) Pub. Date: Aug. 18, 2016

(54) PORTABLE TERMINAL

(71) Applicant: KYOCERA CORPORATION, Kyoto (JP)

(72) Inventors: Yujiro FUKUI, Kawanishi-shi (JP); Miho KANEMATSU, Osaka (JP)

(21) Appl. No.: 15/005,731

(22) Filed: Jan. 25, 2016

(30) Foreign Application Priority Data
Jan. 28, 2015 (JP) 2015-013962

(51) Int. Cl. H04N 5/232; H04N 5/225

(52) U.S. Cl. CPC H04N 5/23245; H04N 5/23293; H04N 5/2258; H04N 5/23219; H04N 5/23212

(57) ABSTRACT

A portable terminal includes a display configured to be located on a front surface of the portable terminal, a front camera configured to be located on the front surface of the portable terminal, and a rear camera configured to be located on a back surface of the portable terminal. A processor is configured to set any camera of the front camera and the rear camera to ON and to have the display display an image input from the camera set to ON. The processor is configured to switch the camera to be set to ON when change in condition around the camera set to ON is detected.

### CROSS-REFERENCE TO RELATED APPLICATION

The present application claims priority under 35 U.S.C. §119 to Japanese Patent Application No. 2015-013962, filed on Jan. 28, 2015, entitled “Portable Terminal”. The content of which is incorporated by reference herein in its entirety.

### FIELD

Embodiments of the present disclosure relate to a portable terminal.

### BACKGROUND

A portable terminal including two cameras of a main camera and a sub camera has conventionally been known.

### SUMMARY

A portable terminal according to one embodiment includes a display unit configured to be located on a front surface of the portable terminal, a front camera configured to be located on the front surface of the portable terminal, a rear camera configured to be located on a back surface of the portable terminal, a storage unit configured to store a control program, and a processor configured to control the portable terminal by executing the control program. The processor is configured to set any camera of the front camera and the rear camera to on and to have the display unit display an image input from the camera set to ON. The processor is configured to switch the camera to be set to ON when change in condition around the camera set to ON is detected.

### BRIEF DESCRIPTION OF THE DRAWINGS

FIG. 1 is a diagram showing a configuration of a portable terminal in an embodiment.

FIG. 2 is a diagram showing appearance of the portable terminal in FIG. 1 from a front (front surface) side.

FIG. 3 is a diagram showing appearance of a portable terminal 1 in FIG. 1 from a rear (back surface) side.

FIG. 4 is a flowchart showing a procedure for shooting oneself in a first embodiment.

FIG. 5 is a diagram showing an operation by a user.

FIG. 6 is a diagram showing an example of a shot still image.

FIG. 7 is a diagram showing an operation by a user.

FIG. 8 is a flowchart showing a procedure for shooting oneself in a second embodiment.

FIGS. 9 and 10 are each a diagram showing an operation by a user.

FIGS. 11 and 12 are flowcharts showing a procedure for shooting oneself in a third embodiment.

FIGS. 13 and 14 are each a diagram showing an operation by a user.

FIGS. 15 and 16 are flowcharts showing a procedure for shooting oneself in a fourth embodiment.

FIG. 17 is a diagram showing an operation by a user.

FIGS. 18 and 19 are flowcharts showing a procedure for shooting oneself and a background in a fifth embodiment.

FIGS. 20 and 21 are each a diagram showing an example of a shot still image.

FIG. 22 is a diagram showing appearance of a portable terminal from a front (front surface) side.

FIG. 23 is a diagram showing appearance of the portable terminal from a rear (back surface) side.

### DETAILED DESCRIPTION

### First Embodiment

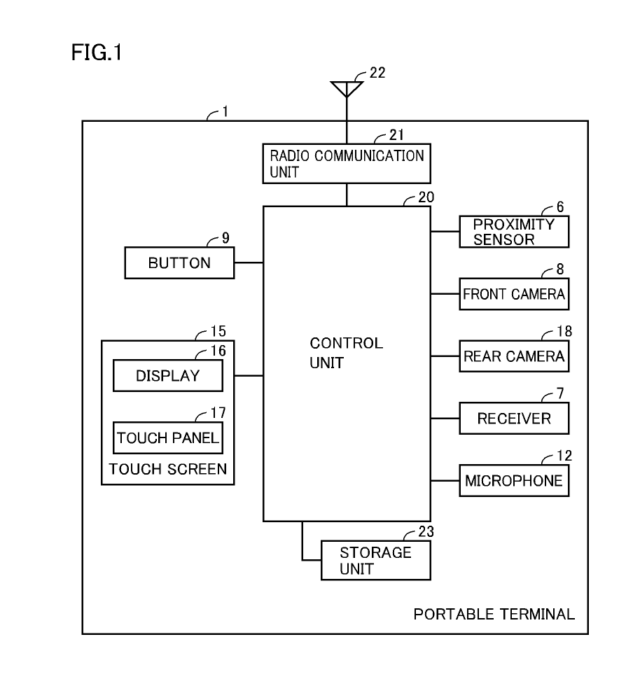

Referring to FIGS. 1, 2, and 3, this portable terminal 1 includes an antenna 22, a radio communication unit 21, a proximity sensor 6, a front camera 8, a rear camera 18, a receiver 7, a microphone 12, a button group 9, a touch screen 15, a control unit 20, and a storage unit 23. Touch screen 15 is constituted of a display 16 and a touch panel 17.

Button group 9 can function as an operation acceptance unit which can accept an instruction operation from a user for various types of processing. Examples of the operation acceptance unit include a button implemented as a physical mechanism (a hardware key) such as button group 9 and a key reproduced as software (a soft key).

Radio communication unit 21 can communicate with a radio base station through antenna 22. Radio communication unit 21 includes an A/D converter, a D/A converter, a modulation unit, a demodulation unit, a frequency converter, and an amplification unit.

Display 16 can display a screen output from control unit 20. Examples of display 16 include a liquid crystal display and an organic electro-luminescence (EL) display.

Touch panel 17 can function as an input acceptance unit which can accept input from a user. Though touch panel 17 detects contact or proximity of an object (a finger of a user or a pen) based on a capacitance, the touch panel is not limited as such. For example, input by a user may be detected based on an infrared technique or an electromagnetic induction technique. Other than the touch panel, for example, a component which accepts input without contact may be acceptable as the input acceptance unit, and a proximity sensor represents such an example. A hardware key may also be acceptable as the input acceptance unit.

Receiver 7 can output voice of a communication counterpart or sound of music data output from control unit 20. Receiver 7 is implemented, for example, by an electromagnetic speaker. Alternatively, receiver 7 may be implemented by a piezoelectric oscillation element and may transmit voice and sound to a user by oscillating a panel on a surface.

Microphone 12 can receive voice of a communication counterpart and sound in the surroundings and output the voice and sound to control unit 20.

Proximity sensor 6 can detect presence of a nearby object in a non-contact manner. Proximity sensor 6 can detect, for example, display 16 being brought closer to a face.

Rear camera 18 and front camera 8 can shoot a subject.

Storage unit 23 can store a control program. Control unit 20 can include a CPU (Central Processing Unit). The CPU can control the portable terminal 1 by executing the control program.

Storage unit 23 can store setting information of rear camera 18 and front camera 8 and can store a still image and moving images generated through shooting. The setting information can include on camera information representing which of front camera 8 and rear camera 18 is set to ON and information representing to which of a still image shooting mode and a moving image shooting mode a current shooting mode has been set. Front camera 8 is set to ON by default (hereinafter, an on camera). When the on camera is switched, control unit 20 can update the on camera information. Even when power of portable terminal 1 is turned off, the on camera information is maintained. The shooting mode is set to the still image shooting mode by default. After the moving image shooting mode is set and moving images are shot, control unit 20 can return the shooting mode to the still image shooting mode.

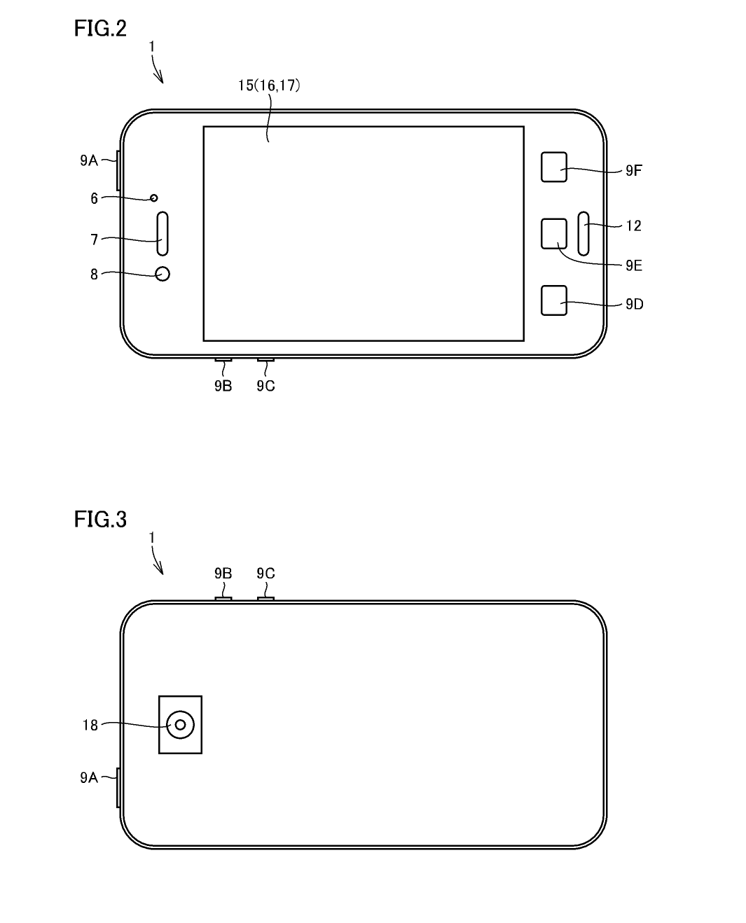

As shown in FIG. 2, receiver 7, front camera 8, and proximity sensor 6 can be arranged in an upper portion of a front surface of a housing 2 of portable terminal 1. Display 16 and touch panel 17 can be arranged in the center of the front surface of housing 2 of portable terminal 1. Touch panel 17 can be arranged on display 16.

Buttons 9D, 9E, and 9F can be arranged in a lower portion of the front surface of housing 2 of portable terminal 1. A button 9A can be arranged on an upper side of a side surface of housing 2 of portable terminal 1. Buttons 9B and 9C can be arranged on a lateral side of a side surface of housing 2 of portable terminal 1.

Button 9D serves as a home button. Button 9E serves as a back button. Button 9F serves as a menu button. Button 9A serves as a power on/off button. Button 9B serves as a volume turn-up button. Button 9C serves as a volume turn-down button.

Microphone 12 can be arranged in the lower portion of the front surface of housing 2 of portable terminal 1.

As shown in FIG. 3, rear camera 18 can be arranged in an upper portion of a rear surface of housing 2 of portable terminal 1.

When a user shoots the user himself/herself with front camera 8 of portable terminal 1, the user has had to switch the camera to be set to ON from rear camera 18 to front camera 8 by touching an icon on touch screen 15. The user has had to further touch another icon on touch screen 15 in order to click a shutter of front camera 8.

Control unit 20 can set any of front camera 8 and rear camera 18 to ON based on the setting information (on camera information) and have display 16 display an image input from the camera set to ON.

Control unit 20 can switch the camera to be set to ON when the camera or a sensor located around the camera detects change in condition around the camera, for example, in response to covering of the camera set to ON by the user. An operation to cover the camera by the user includes an operation by the user to move a hand, a finger, or another body part of the user or an object other than the body of the user toward the camera set to ON. There are various methods for detecting an operation by the user to cover the camera set to ON.

In a first embodiment, control unit 20 can switch the camera to be set to ON based on an image input from the camera set to ON. Specifically, control unit 20 can switch the camera to be set to ON based on whether or not a quantity of light in all areas in the input image indicates a value not greater than a certain value. After control unit 20 switches the camera to be set to ON, it can automatically control face recognition autofocus (AF) and control self-timer shooting.

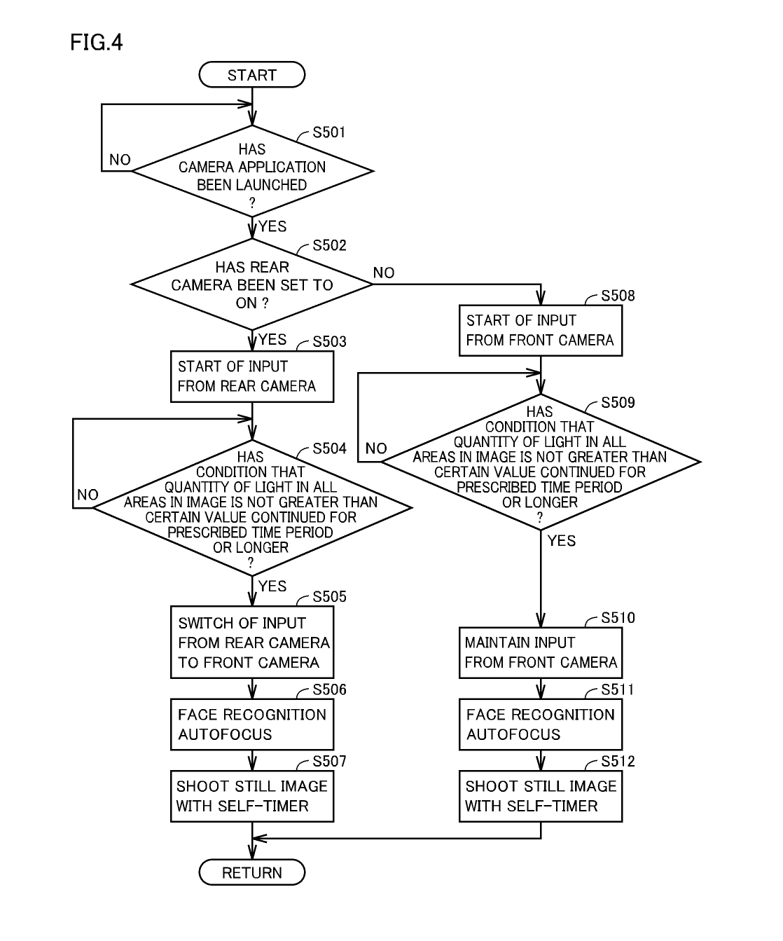

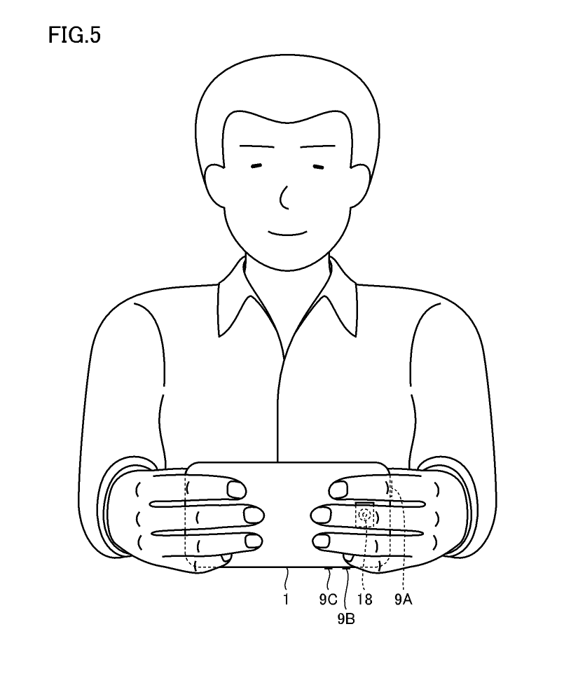

FIG. 4 is a flowchart showing a procedure for shooting oneself in the first embodiment.

Referring to FIG. 4, in step S501, when the user indicates launch of a camera application by touching a camera icon displayed on touch screen 15, the process proceeds to step S502.

When the setting information of the camera stored in storage unit 23 indicates on of rear camera 18 in step S502, control unit 20 allows the process to proceed to step S503. When the setting information of the camera stored in storage unit 23 indicates on of front camera 8, control unit 20 allows the process to proceed to step S508.

In step S503, control unit 20 can start input of an image from rear camera 18 and have the input image displayed on touch screen 15.

In step S504, when a condition that a quantity of light in all areas in the image input from rear camera 18 is not greater than a certain value (that is, a pixel value is not greater than a certain value) continues for a prescribed time period or longer (S504: YES), control unit 20 allows the process to proceed to step S505.

An operation by the user for determination as YES in S504 will be described with reference to FIG. 5.

As shown in FIG. 5, as the user orients front camera 8 to the user himself/herself and covers rear camera 18 with his/her hand for a prescribed time period or longer, a condition that the quantity of light in all areas in the image input from rear camera 18 is not greater than the certain value continues for a prescribed time period or longer, and the process proceeds to step S505. The reason why the quantity of light in all areas being not greater than the certain value has been set as a condition is for distinction from shooting of a night scene.

In step S505, control unit 20 can start input of an image from front camera 8 instead of rear camera 18, and have the input image displayed on touch screen 15. Control unit 20 can update setting information (on camera information) such that front camera 8 is on.

In step S506, control unit 20 can have front camera 8 control face recognition autofocus (AF). Specifically, control unit 20 can detect a position of a face in the image input from front camera 8 and adjust focus of an optical system of front camera 8 such that the detected face is focused on.

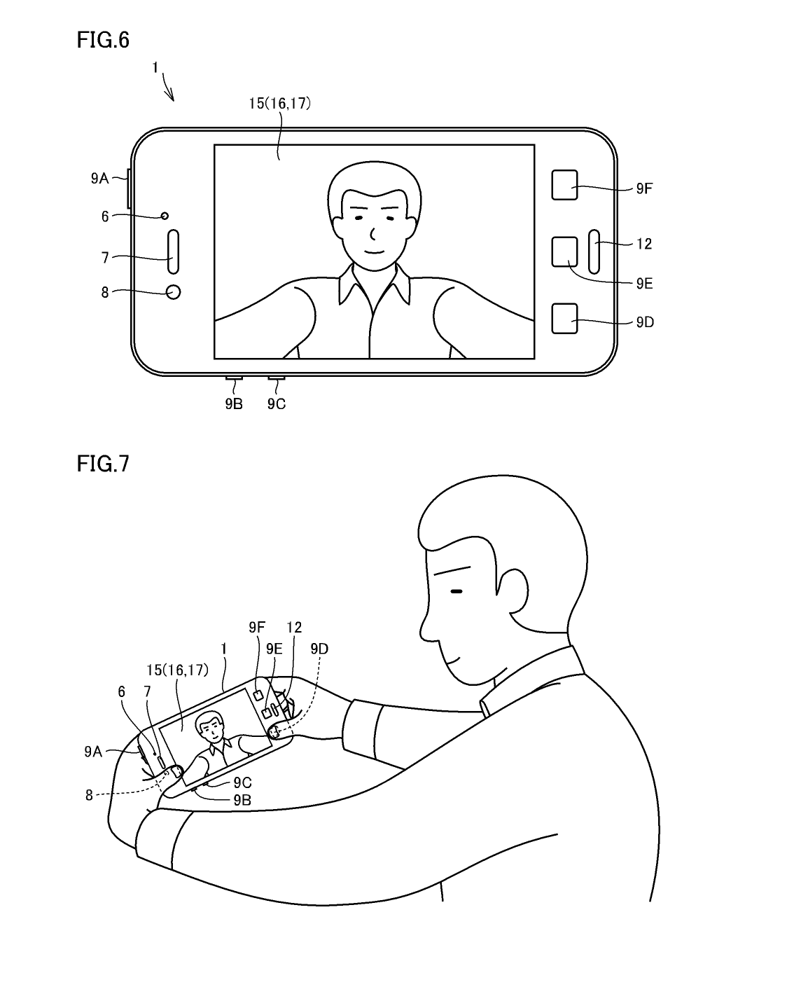

In step S507, control unit 20 can have a still image as shown in FIG. 6 shot with a self-timer function. Specifically, control unit 20 can have storage unit 23 store an image input from front camera 8 after lapse of 10 seconds.

In step S508, control unit 20 can start input of an image from front camera 8 and have the input image displayed on touch screen 15.

In step S509, when the condition that the quantity of light in all areas in the image input from front camera 8 is not greater than the certain value (that is, a pixel value is not greater than the certain value) has continued for the prescribed time period or longer (S509: YES), control unit 20 allows the process to proceed to step S510.

An operation by the user for determination as YES in S509 will be described with reference to FIG. 7.

As shown in FIG. 7, as the user orients front camera 8 toward the user himself/herself and covers front camera 8 with his/her hand for a prescribed time period or longer, a condition that the quantity of light in all areas in the image input from front camera 8 is not greater than the certain value continues for the prescribed time period or longer and the process proceeds to step S510.

In step S510, control unit 20 can maintain input of an image from front camera 8 and have the input image displayed on touch screen 15.

In step S511, control unit 20 can have front camera 8 execute face recognition autofocus (AF). Specifically, control unit 20 can detect a position of a face in the image input from front camera 8 and adjust focus of the optical system of front camera 8 such that the detected face is focused on.

In step S512, control unit 20 can have a still image as shown in FIG. 6 shot with a self-timer function. Specifically, control unit 20 can have storage unit 23 store an image input from front camera 8 after lapse of 10 seconds.

As set forth above, according to the first embodiment, with a simple operation by the user to cover the camera set to ON with his/her hand, the camera to be set to ON can be switched from the rear camera to the front camera.

### Second Embodiment

A second embodiment solves the problem the same as in the first embodiment with a different method.

In the second embodiment, control unit 20 can set any of front camera 8 and rear camera 18 to ON based on setting information (on camera information) and have display 16 display an image input from the camera set to ON. Control unit 20 can switch the camera to be set to ON based on the image input from the camera set to ON. Specifically, control unit 20 can switch the camera to be set to ON based on whether or not a prescribed gesture has been detected in the input image. After control unit 20 switches the camera to be set to ON, it can automatically control face recognition autofocus (AF) and control self-timer shooting.

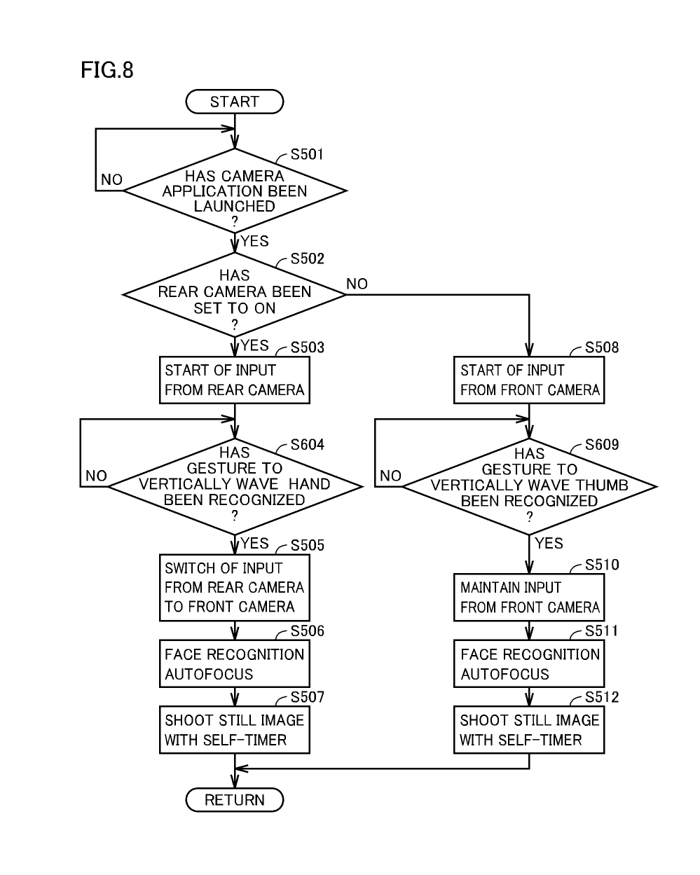

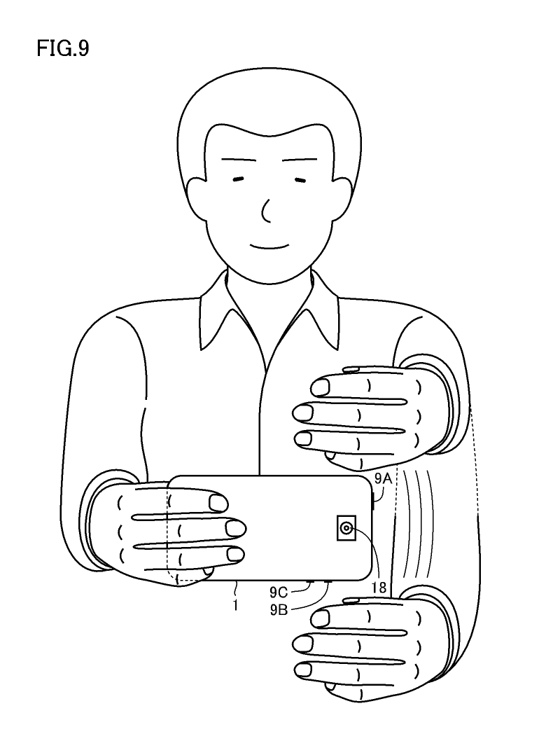

FIG. 8 is a flowchart showing a procedure for shooting oneself in the second embodiment.

The flowchart in FIG. 8 is different from the flowchart in FIG. 4 as follows.

Instead of steps S504 and S509 in FIG. 4, FIG. 8 has steps S604 and S609.

In step S604, when a gesture operation to vertically wave a user's hand is detected in the image input from rear camera 18 (S604: YES), control unit 20 allows the process to proceed to step S505.

FIG. 9 is a diagram showing an operation by a user. FIG. 9 shows an operation by the user for determination as YES in S604.

As shown in FIG. 9, as the user performs an operation to vertically wave his/her hand in front of rear camera 18, the gesture is detected and the process proceeds to step S505.

In step S609, when a gesture operation to vertically wave a user's thumb is detected in the image input from front camera 8 (S609: YES), control unit 20 allows the process to proceed to step S510.

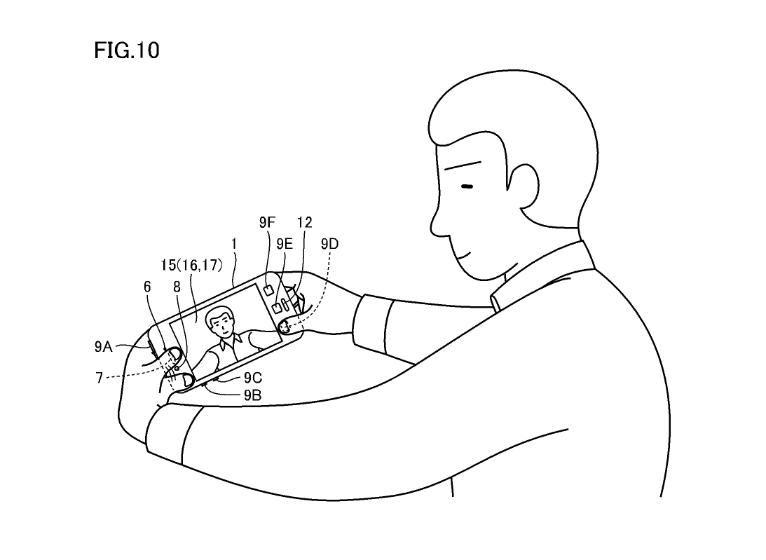

FIG. 10 is a diagram showing an operation by a user. FIG. 10 shows an operation by the user for determination as YES in S609.

As shown in FIG. 10, as the user performs an operation to vertically wave his/her thumb in front of front camera 8, the gesture is detected and the process proceeds to step S510.

As set forth above, according to the second embodiment, with a simple gesture operation by the user to wave his/her hand or finger in front of the camera set to ON, the camera set to ON can be switched from the rear camera to the front camera.

### Third Embodiment

When rear camera 18 is higher in resolution than front camera 8, some users shoot the users themselves with rear camera 18. Some users shoot moving images of the users themselves.

A third embodiment relates to a portable terminal which allows shooting of oneself not only with front camera 8 but also with rear camera 18 and allows shooting of not only still images but also moving images of oneself.

In the third embodiment, when a duration of a condition that a quantity of light in all areas in an image input from rear camera 18 is not greater than a certain value is within a first prescribed range while rear camera 18 is set to ON, control unit 20 can switch the camera to be set to ON from rear camera 18 to front camera 8, and when the duration of the condition that the quantity of light is not greater than the certain value is within a second prescribed range, control unit 20 can maintain rear camera 18 as the camera to be set to ON.

When an event that the quantity of light in all areas in the image input from rear camera 18 varies to a value not greater than the certain value and thereafter exceeds the certain value occurs N or more times (N being a natural number not smaller than 2) within a certain time period while rear camera 18 is set to ON, control unit 20 can switch the camera to be set to ON from rear camera 18 to front camera 8 and switch the shooting mode from the still image shooting mode to the moving image shooting mode.

When the duration of the condition that the quantity of light in all areas in the image input from front camera 8 is not greater than the certain value is within the first prescribed range while front camera 8 is set to ON, control unit 20 can maintain front camera 8 as the camera to be set to ON, and when the duration of the condition that the quantity of light is not greater than the certain value is within the second prescribed range, control unit 20 can switch the camera to be set to ON from front camera 8 to rear camera 18.

When an event that the quantity of light in all areas in the image input from front camera 8 varies to a value not greater than the certain value and thereafter exceeds the certain value occurs N or more times (N being a natural number not smaller than 2) within the certain time period while front camera 8 is set to ON, control unit 20 can maintain front camera 8 as the camera to be set to ON and switch the shooting mode from the still image shooting mode to the moving image shooting mode.

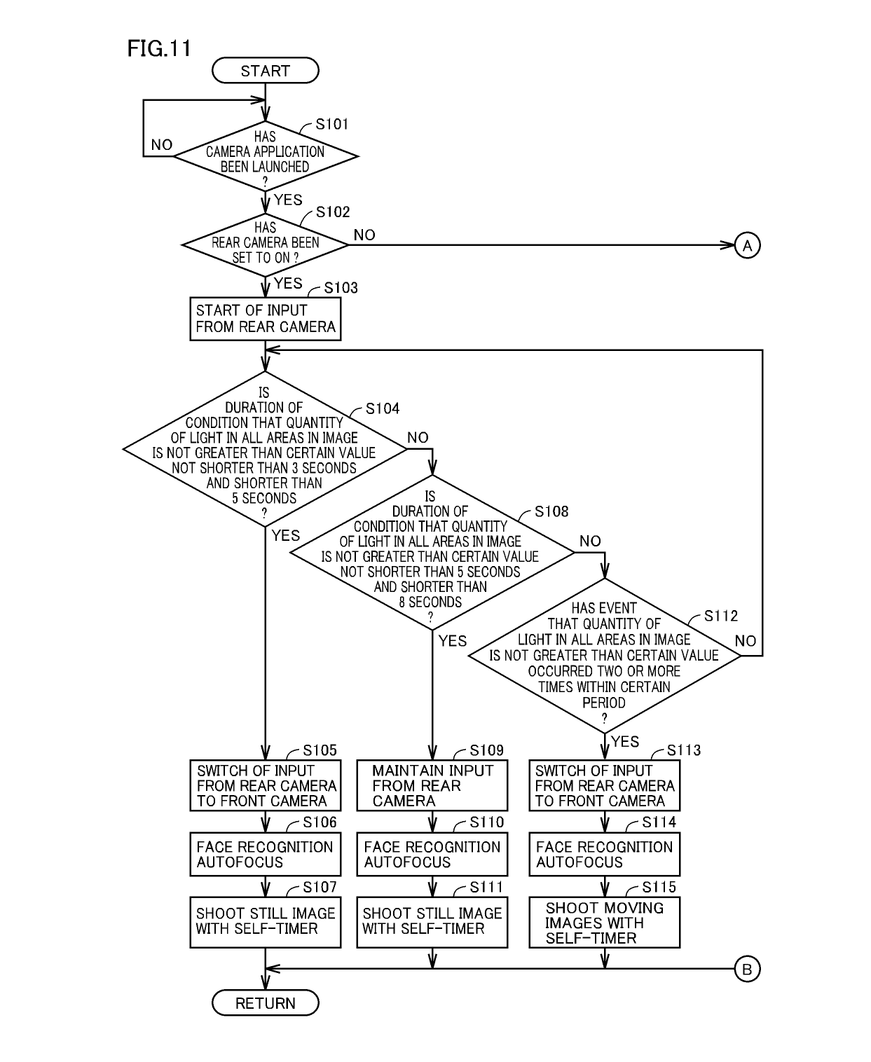

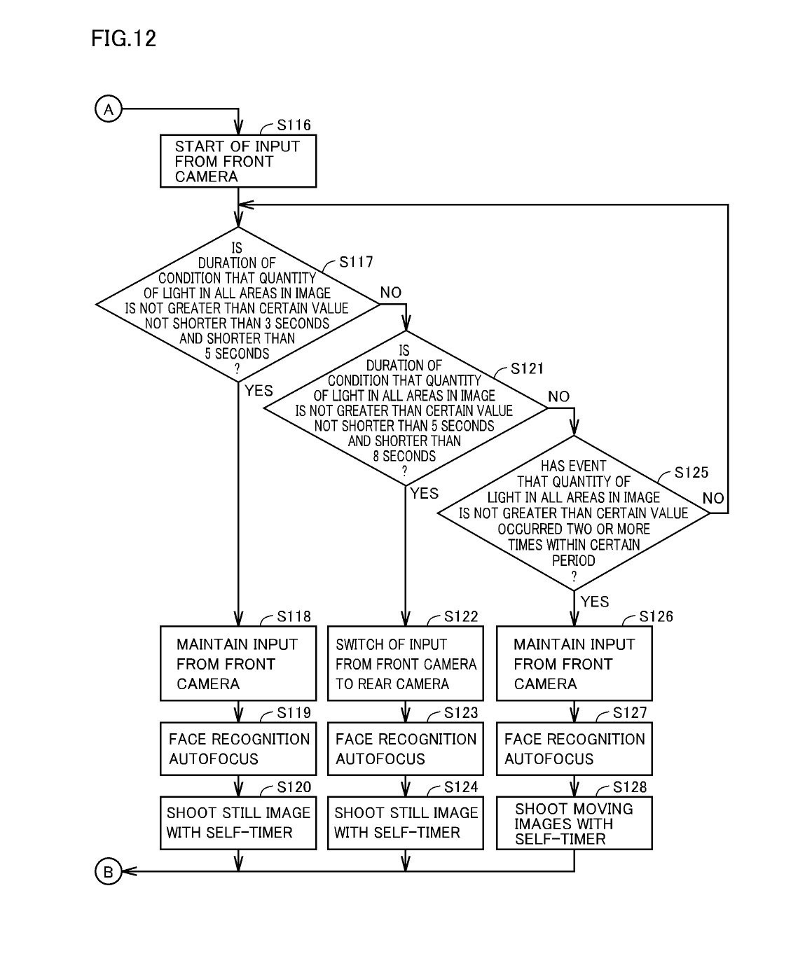

FIGS. 11 and 12 are flowcharts showing a procedure for shooting oneself in the third embodiment.

Referring to FIGS. 11 and 12, when the user indicates launch of a camera application in step S101 by touching a camera icon displayed on touch screen 15, the process proceeds to step S102.

When the setting information of the camera stored in storage unit 23 indicates on of rear camera 18 in step S102, control unit 20 allows the process to proceed to step S103. When the setting information of the camera stored in storage unit 23 indicates on of front camera 8, control unit 20 allows the process to proceed to step S116.

In step S103, control unit 20 can start input of an image from rear camera 18 and have the input image displayed on touch screen 15.

In S104, when a duration of the condition that the quantity of light in all areas in the image input from rear camera 18 is not greater than the certain value (that is, a pixel value is not greater than the certain value) is within a first prescribed range (a period not shorter than 3 seconds and shorter than 5 seconds) (S104: YES), control unit 20 allows the process to proceed to step S105.

An operation by the user for determination as YES in S104 will be described with reference to FIG. 5.

As shown in FIG. 5, as the user orients front camera 8 toward the user himself/herself and covers rear camera 18 with his/her hand for a period not shorter than 3 seconds and shorter than 5 seconds, the duration of the condition that the quantity of light in all areas in the image input from rear camera 18 is not greater than the certain value is within the first prescribed range (not shorter than 3 seconds and shorter than 5 seconds) and the process proceeds to step S105.

In step S105, control unit 20 can start input of an image from front camera 8 instead of rear camera 18 and have the input image displayed on touch screen 15. Control unit 20 can update the setting information (on camera information) such that front camera 8 is on.

In step S106, control unit 20 can have front camera 8 execute face recognition autofocus (AF). Specifically, control unit 20 can detect a position of a face in the image input from front camera 8 and adjust focus of an optical system of front camera 8 such that the detected face is focused on.

In step S107, control unit 20 can have a still image as shown in FIG. 6 shot with a self-timer function. Specifically, control unit 20 can have storage unit 23 store an image input from front camera 8 after lapse of 10 seconds.

When the duration of the condition that the quantity of light in all areas in the image input from rear camera 18 is not greater than the certain value (that is, a pixel value is not greater than the certain value) is within the second prescribed range (not shorter than 5 seconds and shorter than 8 seconds) (S104: NO, S108: YES), control unit 20 allows the process to proceed to step S109.

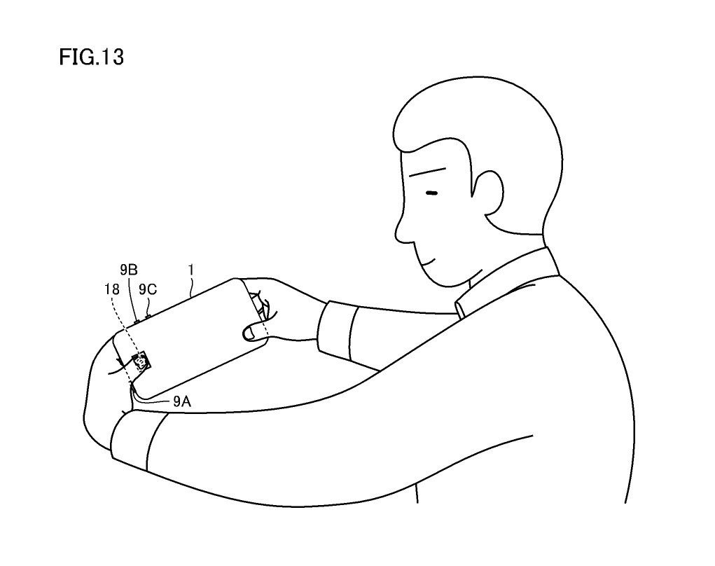

An operation by the user for determination as YES in S108 will be described with reference to FIG. 13.

As shown in FIG. 13, as the user orients rear camera 18 toward the user himself/herself and covers rear camera 18 with his/her hand for a period not shorter than 5 seconds and shorter than 8 seconds, the duration of the condition that the quantity of light in all areas in the image input from rear camera 18 is not greater than the certain value is within the second prescribed range (not shorter than 5 seconds and shorter than 8 seconds) and the process proceeds to step S109.

In step S109, control unit 20 can maintain input of the image from rear camera 18 and have the input image displayed on touch screen 15.

In step S110, control unit 20 can have rear camera 18 execute face recognition autofocus (AF). Specifically, control unit 20 can detect a position of a face in the image input from rear camera 18 and adjust focus of an optical system of rear camera 18 such that the detected face is focused on.

In step S111, control unit 20 can have a still image as shown in FIG. 6 shot with a self-timer function. Specifically, control unit 20 can have storage unit 23 store an image input from rear camera 18 after lapse of 10 seconds.

When an event that the quantity of light in all areas in the image input from rear camera 18 varies to a value not greater than the certain value and thereafter exceeds the certain value occurs two or more times within the certain time period (for example, 10 seconds) (S104: NO, S108: NO, S112: YES), control unit 20 allows the process to proceed to step S113.

An operation by the user for determination as YES in S112 will be described with reference to FIG. 5.

As shown in FIG. 5, as the user orients front camera 8 toward the user himself/herself and performs an operation to cover rear camera 18 with his/her hand twice or more within the certain time period, an event that the quantity of light in all areas in the image input from rear camera 18 varies to a value not greater than the certain value and thereafter exceeds the certain value occurs twice or more within the certain time period, and the process proceeds to step S113.

In step S113, control unit 20 can start input of an image from front camera 8 instead of rear camera 18 and have the input image displayed on touch screen 15. Control unit 20 can update the setting information (on camera information) such that front camera 8 is on and switch the shooting mode to the moving image shooting mode.

In step S114, control unit 20 can have front camera 8 execute face recognition autofocus (AF). Specifically, control unit 20 can detect a position of a face in the image input from front camera 8 and adjust focus of an optical system of front camera 8 such that the detected face is focused on.

In step S115, control unit 20 can have moving images shot with a self-timer function. Specifically, control unit 20 can have storage unit 23 store video images (moving images) input from front camera 8 after lapse of 10 seconds.

In step S116, control unit 20 can start input of an image from front camera 8 and have the input image displayed on touch screen 15.

When the duration of the condition that the quantity of light in all areas in the image input from front camera 8 is not greater than the certain value (that is, a pixel value is not greater than the certain value) is within the first prescribed range (a period not shorter than 3 seconds and shorter than 5 seconds) (S117: YES), control unit 20 allows the process to proceed to step S118.

An operation by the user for determination as YES in S117 will be described with reference to FIG. 7.

As shown in FIG. 7, as the user orients front camera 8 toward the user himself/herself and covers front camera 8 with his/her hand for a period not shorter than 3 seconds and shorter than 5 seconds, the duration of the condition that the quantity of light in all areas in the image input from front camera 8 is not greater than the certain value is within the first prescribed range (not shorter than 3 seconds and shorter than 5 seconds) and the process proceeds to step S118.

In step S118, control unit 20 can have input of an image from front camera 8 maintained and have the input image displayed on touch screen 15.

In step S119, control unit 20 can have front camera 8 execute face recognition autofocus (AF). Specifically, control unit 20 can detect a position of a face in the image input from front camera 8 and adjust focus of an optical system of front camera 8 such that the detected face is focused on.

In step S120, control unit 20 can have a still image as shown in FIG. 6 shot with a self-timer function. Specifically, control unit 20 can have storage unit 23 store an image input from front camera 8 after lapse of 10 seconds.

When the duration of the condition that the quantity of light in all areas in the image input from front camera 8 is not greater than the certain value (that is, a pixel value is not greater than the certain value) is within the second prescribed range (not shorter than 5 seconds and shorter than 8 seconds) (S117: NO, S121: YES), control unit 20 allows the process to proceed to step S122.

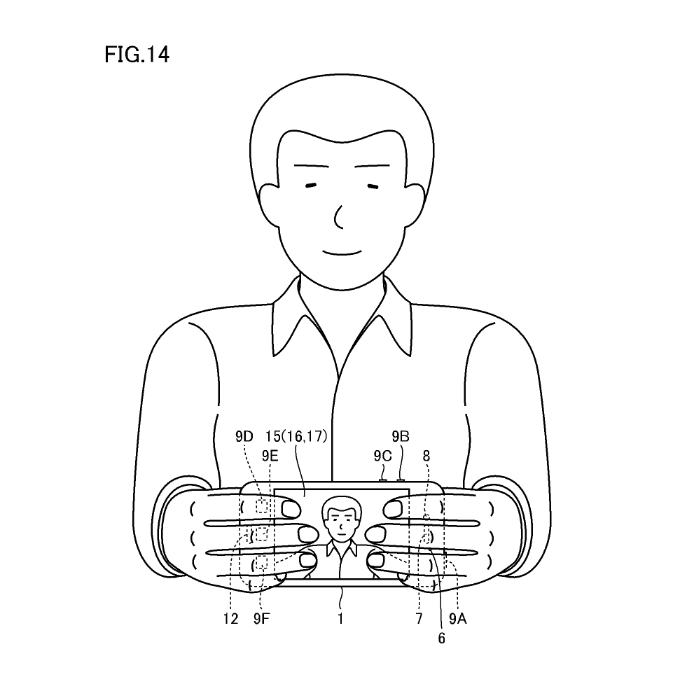

An operation by the user for determination as YES in S121 will be described with reference to FIG. 14.

As shown in FIG. 14, as the user orients rear camera 18 toward the user himself/herself and covers front camera 8 with his/her hand for a period not shorter than 5 seconds and shorter than 8 seconds, the duration of the condition that the quantity of light in all areas in the image input from front camera 8 is not greater than the certain value is within the second prescribed range (not shorter than 5 seconds and shorter than 8 seconds) and the process proceeds to step S122.

In step S122, control unit 20 can start input of an image from rear camera 18 instead of front camera 8 and have the input image displayed on touch screen 15. Control unit 20 can update the setting information (on camera information) such that rear camera 18 is on.

In step S123, control unit 20 can have rear camera 18 execute face recognition autofocus (AF). Specifically, control unit 20 can detect a position of a face in the image input from rear camera 18 and adjust focus of an optical system of rear camera 18 such that the detected face is focused on.

In step S124, control unit 20 can have a still image as shown in FIG. 6 shot with a self-timer function. Specifically, control unit 20 can have storage unit 23 store an image input from rear camera 18 after lapse of 10 seconds.

When an event that the quantity of light in all areas in the image input from front camera 8 varies to a value not greater than the certain value and thereafter exceeds the certain value occurs twice or more within the certain time period (for example, 10 seconds) (S117: NO, S121: NO, S125: YES), control unit 20 allows the process to proceed to step S126.

An operation by the user for determination as YES in S125 will be described with reference to FIG. 7.

As shown in FIG. 7, as the user orients front camera 8 toward the user himself/herself and performs an operation to cover front camera 8 with his/her hand twice or more within a prescribed time period, an event that the quantity of light in all areas in the image input from front camera 8 varies to a value not greater than the certain value and thereafter exceeds the certain value occurs twice or more within the certain time period, and the process proceeds to step S126.

In step S126, control unit 20 can have input of an image from front camera 8 maintained and have the input image displayed on touch screen 15. Control unit 20 can switch the shooting mode to the moving image shooting mode.

In step S127, control unit 20 can have front camera 8 execute face recognition autofocus (AF). Specifically, control unit 20 can detect a position of a face in the image input from front camera 8 and adjust focus of an optical system of front camera 8 such that the detected face is focused on.

In step S128, control unit 20 can have moving images shot with a self-timer function. Specifically, control unit 20 can have storage unit 23 store video images (moving images) input from front camera 8 after lapse of 10 seconds.

As set forth above, according to the third embodiment, as the user changes how to wave his/her hand or finger in front of the camera set to ON, the camera to be set to ON can be maintained, the camera to be set to ON can be switched, or the shooting mode can be switched to an operation shooting mode.

### Fourth Embodiment

A fourth embodiment solves the problem the same as in the third embodiment with a different method.

In the fourth embodiment, when the duration of the condition that the quantity of light in all areas in the image input from rear camera 18 is not greater than the certain value is within a prescribed range while rear camera 18 is set to ON, control unit 20 can switch the camera to be set to ON from rear camera 18 to front camera 8 or can maintain rear camera 18 as the camera to be set to ON based on whether or not proximity sensor 6 detects proximity of an object.

When the duration of the condition that the quantity of light in all areas in the image input from front camera 8 is not greater than the certain value is within the prescribed range while front camera 8 is set to ON, control unit 20 can switch the camera to be set to ON from front camera 8 to rear camera 18 or can maintain front camera 8 as the camera to be set to ON based on whether or not proximity sensor 6 detects proximity of an object.

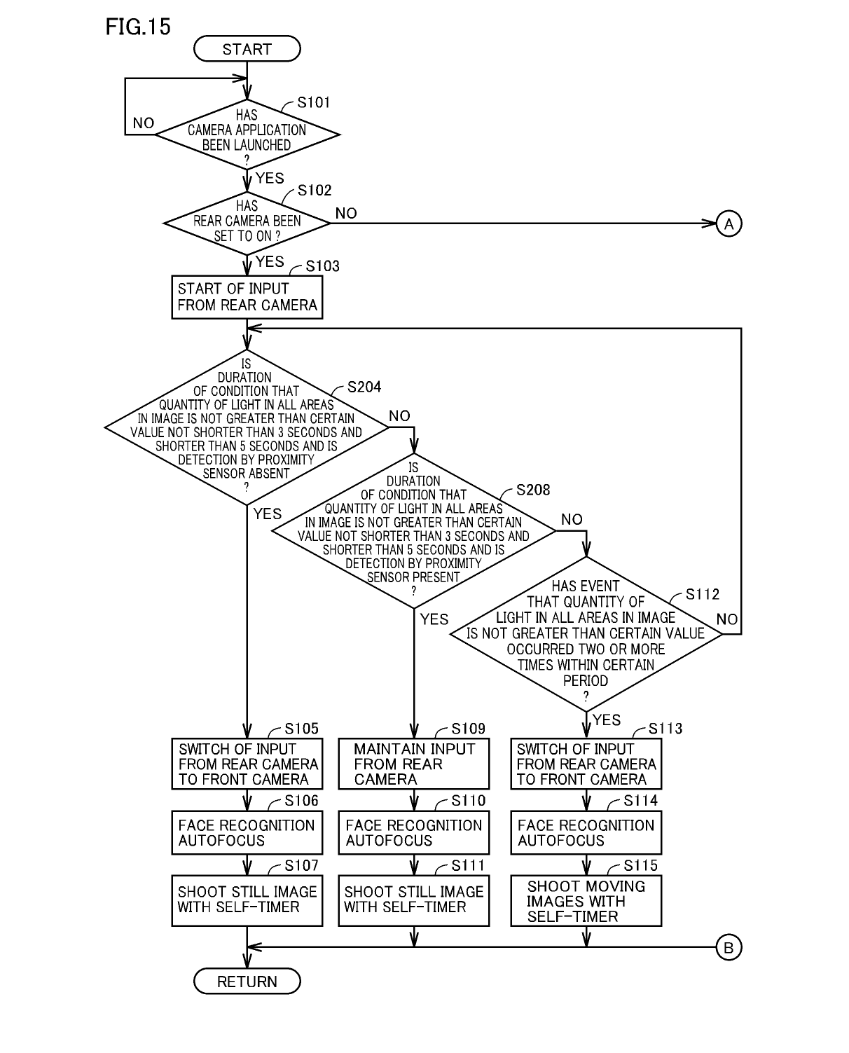

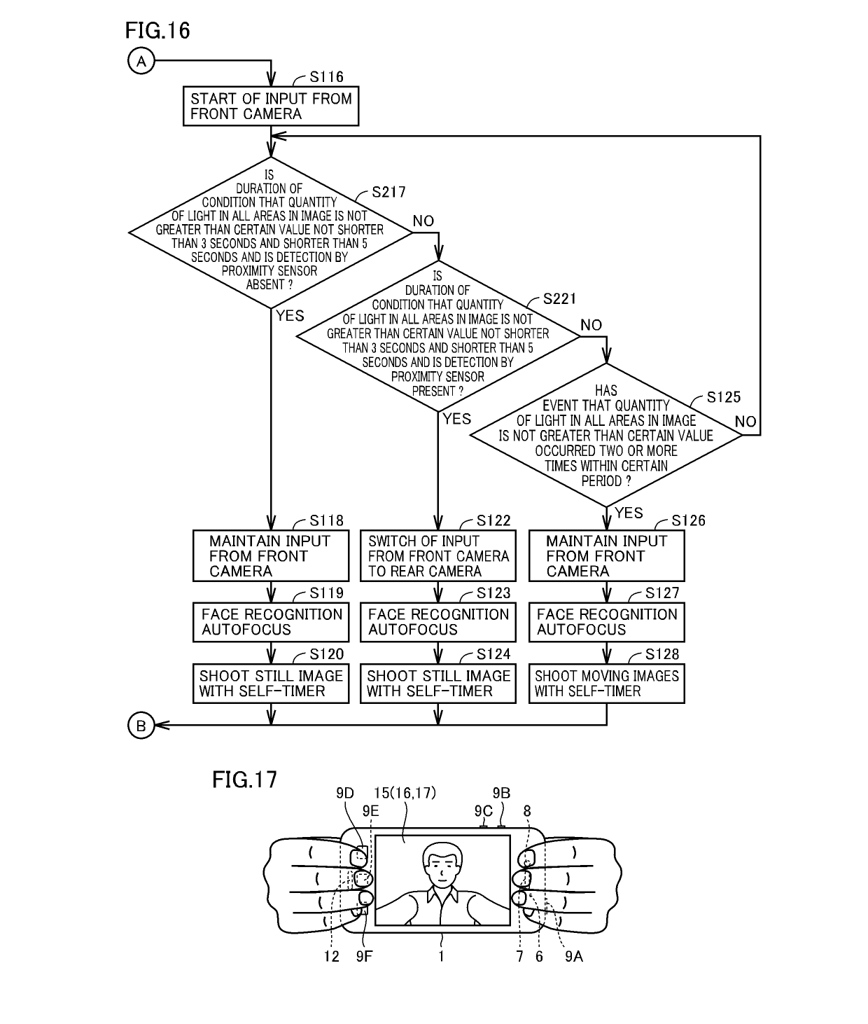

FIGS. 15 and 16 are flowcharts showing a procedure for shooting oneself in the fourth embodiment.

The flowcharts in FIGS. 15 and 16 are different from the flowcharts in FIGS. 11 and 12 as follows.

Instead of steps S104, S108, S117, and S121 in FIG. 11, FIG. 14 has steps S204, S208, S217, and S221.

In step S204, when the duration of the condition that the quantity of light in all areas in the image input from rear camera 18 is not greater than the certain value (that is, a pixel value is not greater than the certain value) is within the first prescribed range (a period not shorter than 3 seconds and shorter than 5 seconds) and when detection of an object by proximity sensor 6 is absent (S204: YES), control unit 20 allows the process to proceed to step S105.

An operation by the user for determination as YES in S204 will be described with reference to FIG. 5.

As shown in FIG. 5, though the user orients front camera 8 toward the user himself/herself and covers rear camera 18 with his/her hand for a period not shorter than 3 seconds and shorter than 5 seconds, the user's hand is not proximate to sensor 6. Thus, the duration of the condition that the quantity of light in all areas in the image input from rear camera 18 is not greater than the certain value is within the first prescribed range (not shorter than 3 seconds and shorter than 5 seconds) and approach of an object (the user's hand) is not detected by proximity sensor 6. Therefore, the process proceeds to step S105.

In step S208, when the duration of the condition that the quantity of light in all areas in the image input from rear camera 18 is not greater than the certain value (that is, a pixel value is not greater than the certain value) is within the first prescribed range (a period not shorter than 3 seconds and shorter than 5 seconds) and when detection of an object by proximity sensor 6 is present (S208: YES), control unit 20 allows the process to proceed to step S109.

An operation by the user for determination as YES in S208 will be described with reference to FIG. 17.

As shown in FIG. 17, the user orients rear camera 18 toward the user himself/herself and covers rear camera 18 with his/her hand for a period not shorter than 3 seconds and shorter than 5 seconds, and the user's hand is proximate to proximity sensor 6. Thus, the duration of the condition that the quantity of light in all areas in the image input from rear camera 18 is not greater than the certain value is within the first prescribed range (not shorter than 3 seconds and shorter than 5 seconds) and approach of an object (the user's hand) is detected by proximity sensor 6. Therefore, the process proceeds to step S109.

In step S217, when the duration of the condition that the quantity of light in all areas in the image input from front camera 8 is not greater than the certain value (that is, a pixel value is not greater than the certain value) is within the first prescribed range (a period not shorter than 3 seconds and shorter than 5 seconds) and when detection of an object by proximity sensor 6 is absent (S217: YES), control unit 20 allows the process to proceed to step S118.

An operation by the user for determination as YES in S217 will be described with reference to FIG. 7.

As shown in FIG. 7, though the user orients front camera 8 toward the user himself/herself and covers front camera 8 with his/her hand for a period not shorter than 3 seconds and shorter than 5 seconds, the user's hand is not proximate to proximity sensor 6. Thus, the duration of the condition that the quantity of light in all areas in the image input from front camera 8 is not greater than the certain value is within the first prescribed range (not shorter than 3 seconds and shorter than 5 seconds) and approach of an object (the user's hand) is not detected by proximity sensor 6. Therefore, the process proceeds to step S118.

In S221, when the duration of the condition that the quantity of light in all areas in the image input from front camera 8 is not greater than the certain value (that is, a pixel value is not greater than the certain value) is within the first prescribed range (a period not shorter than 3 seconds and shorter than 5 seconds) and when detection of an object by proximity sensor 6 is present (S221: YES), control unit 20 allows the process to proceed to step S122.

An operation by the user for determination as YES in S221 will be described with reference to FIG. 14.

As shown in FIG. 14, the user orients rear camera 18 toward the user himself/herself and covers front camera 8 with his/her hand for a period not shorter than 5 seconds and shorter than 8 seconds, and the user's hand is proximate to proximity sensor 6. Thus, the duration of the condition that the quantity of light in all areas in the image input from front camera 8 is not greater than the certain value is within the first prescribed range (not shorter than 3 seconds and shorter than 5 seconds) and approach of an object (the user's hand) is detected by proximity sensor 6. Therefore, the process proceeds to step S122.

As set forth above, according to the fourth embodiment, as the user changes how to wave his/her hand or finger in front of the camera set to ON or changes approach of his/her hand or finger to the proximity sensor, the camera to be set to ON can be maintained, the camera to be set to ON can be switched, or the shooting mode can be switched to the operation shooting mode.

### Fifth Embodiment

Some portable terminals can generate a photograph synthesized from images input from not only one camera but also from two cameras.

A fifth embodiment relates to a portable terminal which can switch any of front camera 8 and rear camera 18 between a main camera and a sub camera.

In the fifth embodiment, control unit 20 can set one of front camera 8 and rear camera 18 as the main camera and set the other camera as the sub camera, and can have an image input from the main camera displayed in a first region (a main image area large in display region) of display 16 and have an image input from the sub camera displayed in a second region (a sub image area small in display region) of display 16.

Control unit 20 can switch a camera to be set as the main camera based on an image input from the camera set as the main camera.

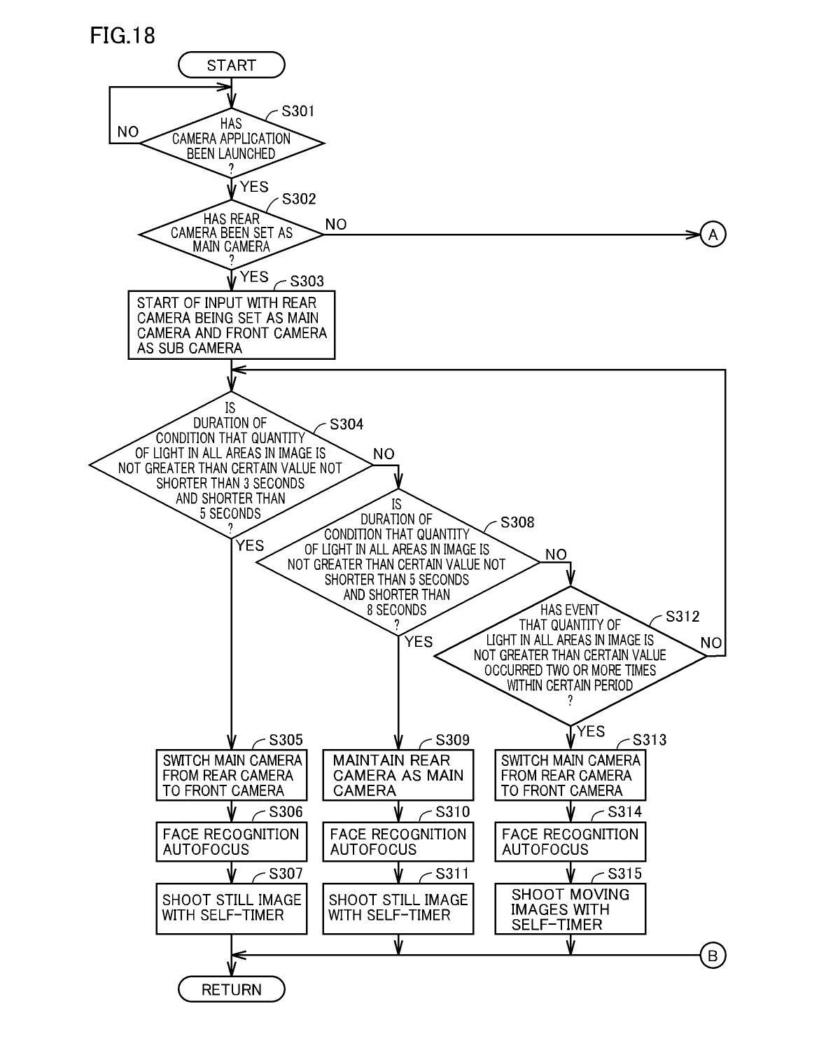

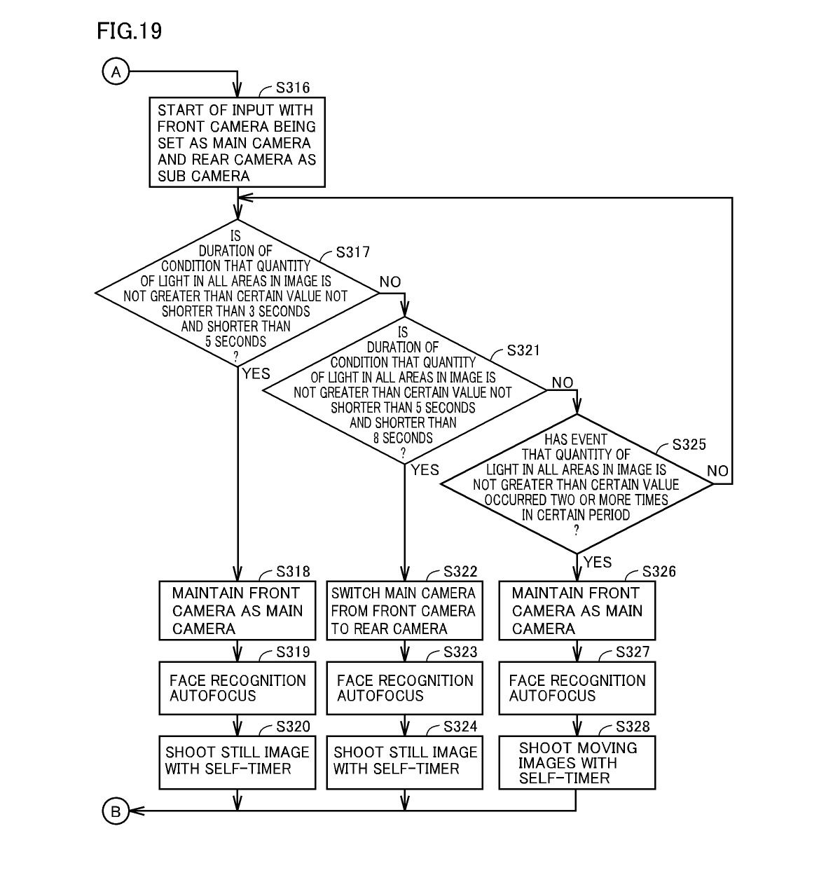

FIGS. 18 and 19 are flowcharts showing a procedure for shooting oneself and a background in the fifth embodiment.

Referring to FIGS. 18 and 19, when the user indicates in step S301 launch of a camera application by touching a camera icon displayed on touch screen 15, the process proceeds to step S302.

When the setting information of the camera stored in storage unit 23 indicates setting of rear camera 18 as the main camera in step S302, control unit 20 allows the process to proceed to step S303. When the setting information of the camera stored in storage unit 23 indicates setting of front camera 8 as the main camera, control unit 20 allows the process to proceed to step S316.

In step S303, control unit 20 can start input of an image with rear camera 18 being set as the main camera and have the input image displayed in the main image area of touch screen 15. Control unit 20 can start input of an image with front camera 8 being set as the sub camera and have the input image displayed in the sub image area of touch screen 15.

When the duration of the condition that the quantity of light in all areas in the image input from rear camera 18 is not greater than the certain value (that is, a pixel value is not greater than the certain value) is within the first prescribed range (a period not shorter than 3 seconds and shorter than 5 seconds) (S304: YES), control unit 20 allows the process to proceed to step S305.

An operation by the user for determination as YES in S304 will be described with reference to FIG. 5.

As shown in FIG. 5, as the user orients front camera 8 toward the user himself/herself and covers rear camera 18 with his/her hand for a period not shorter than 3 seconds and shorter than 5 seconds, the duration of the condition that the quantity of light in all areas in the image input from rear camera 18 is not greater than the certain value is within the first prescribed range (not shorter than 3 seconds and shorter than 5 seconds) and the process proceeds to step S305.

In step S305, control unit 20 can switch the main camera from rear camera 18 to front camera 8. Specifically, input of an image can be started with front camera 8 being set as the main camera and the input image can be displayed in the main image area of touch screen 15. Control unit 20 can start input of the image with rear camera 18 being set as the sub camera and have the input image displayed in the sub image area of touch screen 15. Control unit 20 can update the setting information (on camera information) such that front camera 8 is set as the main camera.

In step S306, control unit 20 can have front camera 8 execute face recognition autofocus (AF). Specifically, control unit 20 can detect a position of a face in the image input from front camera 8 and adjust focus of an optical system of front camera 8 such that the detected face is focused on.

In step S307, control unit 20 can have a still image as shown in FIG. 6 shot with a self-timer function. Specifically, control unit 20 can have storage unit 23 store an image including an image input from rear camera 18 in a sub image area 350 and including an image input from front camera 8 in a main image area 351 after lapse of 10 seconds.

In step S308, when the duration of the condition that the quantity of light in all areas in the image input from rear camera 18 is not greater than the certain value (that is, a pixel value is not greater than the certain value) is within the second prescribed range (not shorter than 5 seconds and shorter than 8 seconds) (S304: NO, S308: YES), control unit 20 allows the process to proceed to step S309.

An operation by the user for determination as YES in S308 will be described with reference to FIG. 13.

As shown in FIG. 13, as the user orients rear camera 18 toward the user himself/herself and covers rear camera 18 with his/her hand for a period not shorter than 5 seconds and shorter than 8 seconds, the duration of the condition that the quantity of light in all areas in the image input from rear camera 18 is not greater than the certain value is within the second prescribed range (not shorter than 5 seconds and shorter than 8 seconds) and the process proceeds to step S309.

In step S309, control unit 20 can maintain rear camera 18 as the main camera and maintain front camera 8 as the sub camera.

In step S310, control unit 20 can have rear camera 18 execute face recognition autofocus (AF). Specifically, control unit 20 can detect a position of a face in the image input from rear camera 18 and adjust focus of an optical system of rear camera 18 such that the detected face is focused on.

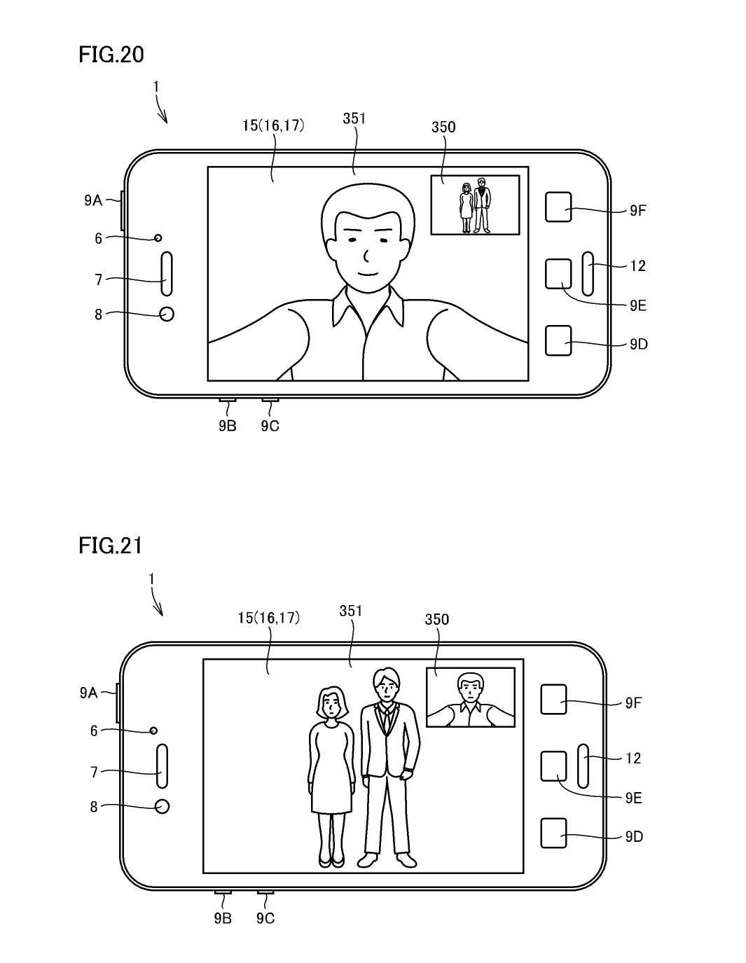

In step S311, control unit 20 can have a still image as shown in FIG. 20 shot with a self-timer function. Specifically, control unit 20 can have storage unit 23 store an image including an image input from front camera 8 in sub image area 350 and including an image input from rear camera 18 in main image area 351 after lapse of 10 seconds.

In step S312, when an event that the quantity of light in all areas in the image input from rear camera 18 varies to a value not greater than the certain value and thereafter exceeds the certain value occurs twice or more within the certain time period (for example, 10 seconds) (S304: NO, S308: NO, S312: YES), control unit 20 allows the process to proceed to step S313.

An operation by the user for determination as YES in S312 will be described with reference to FIG. 5.

As shown in FIG. 5, as the user orients front camera 8 toward the user himself/herself and performs an operation to cover rear camera 18 with his/her hand twice or more within a certain time period, an event that the quantity of light in all areas in the image input from rear camera 18 varies to a value not greater than the certain value and thereafter exceeds the certain value occurs twice or more within a certain time period, and the process proceeds to step S313.

In step S313, control unit 20 can switch the main camera from rear camera 18 to front camera 8. Specifically, input of an image can be started with front camera 8 being set as the main camera and the input image can be displayed in the main image area of touch screen 15. Control unit 20 can start input of the image with rear camera 18 being set as the sub camera and have the input image displayed in the sub image area of touch screen 15. Control unit 20 can update the setting information (on camera information) such that front camera 8 is set as the main camera and switch the shooting mode to the moving image shooting mode.

In step S314, control unit 20 can have front camera 8 execute face recognition autofocus (AF). Specifically, control unit 20 can detect a position of a face in the image input from front camera 8 and adjust focus of an optical system of front camera 8 such that the detected face is focused on.

In step S315, control unit 20 can have moving images shot with a self-timer function. Specifically, control unit 20 can have storage unit 23 store moving images including an image input from rear camera 18 in the sub image area and including an image input from front camera 8 in the main image area after lapse of 10 seconds.

In step S316, control unit 20 can start input of an image with front camera 8 being set as the main camera and have the input image displayed in the main image area of touch screen 15. Control unit 20 can start input of an image with rear camera 18 being set as the sub camera and have the input image displayed in the sub image area of touch screen 15.

In step S317, when the duration of the condition that the quantity of light in all areas in the image input from front camera 8 is not greater than the certain value (that is, a pixel value is not greater than the certain value) is within the first prescribed range (a period not shorter than 3 seconds and shorter than 5 seconds) (S317: YES), control unit 20 allows the process to proceed to step S318.

An operation by the user for determination as YES in S317 will be described with reference to FIG. 7.

As shown in FIG. 7, as the user orients front camera 8 toward the user himself/herself and covers front camera 8 with his/her hand for a period not shorter than 3 seconds and shorter than 5 seconds, the duration of the condition that the quantity of light in all areas in the image input from front camera 8 is not greater than the certain value is within the first prescribed range (not shorter than 3 seconds and shorter than 5 seconds) and the process proceeds to step S318.

In step S318, control unit 20 can maintain front camera 8 as the main camera and maintain rear camera 18 as the sub camera.

In step S319, control unit 20 can have front camera 8 execute face recognition autofocus (AF). Specifically, control unit 20 can detect a position of a face in the image input from front camera 8 and adjust focus of an optical system of front camera 8 such that the detected face is focused on.

In step S320, control unit 20 can have a still image as shown in FIG. 20 shot with a self-timer function. Specifically, control unit 20 can have storage unit 23 store an image including an image input from rear camera 18 in sub image area 350 and including an image input from front camera 8 in main image area 351 after lapse of 10 seconds.

In step S321, when the duration of the condition that the quantity of light in all areas in the image input from front camera 8 is not greater than the certain value (that is, a pixel value is not greater than the certain value) is within the second prescribed range (not shorter than 5 seconds and shorter than 8 seconds) (S317: NO, S321: YES), control unit 20 allows the process to proceed to step S322.

An operation by the user for determination as YES in S321 will be described with reference to FIG. 14.

As shown in FIG. 14, as the user orients rear camera 18 toward the user himself/herself and covers front camera 8 with his/her hand for a period not shorter than 5 seconds and shorter than 8 seconds, the duration of the condition that the quantity of light in all areas in the image input from front camera 8 is not greater than the certain value is within the second prescribed range (not shorter than 5 seconds and shorter than 8 seconds) and the process proceeds to step S322.

In step S322, control unit 20 can switch the main camera from front camera 8 to rear camera 18. Specifically, control unit 20 can start input of an image with rear camera 18 being set as the main camera and have the input image displayed in the main image area of touch screen 15. Control unit 20 can start input of an image with front camera 8 being set as the sub camera and have the input image displayed in the sub image area of touch screen 15. Control unit 20 can update the setting information (on camera information) such that rear camera 18 is set as the main camera.

In step S323, control unit 20 can have rear camera 18 execute face recognition autofocus (AF). Specifically, control unit 20 can detect a position of a face in the image input from rear camera 18 and adjust focus of an optical system of rear camera 18 such that the detected face is focused on.

In step S324, control unit 20 can have a still image as shown in FIG. 20 shot with a self-timer function. Specifically, control unit 20 can have storage unit 23 store an image including an image input from front camera 8 in sub image area 350 and including an image input from rear camera 18 in main image area 351 after lapse of 10 seconds.

In step S325, when an event that the quantity of light in all areas in the image input from front camera 8 varies to a value not greater than the certain value and thereafter exceeds the certain value occurs twice or more within the certain time period (for example, 10 seconds) (S317: NO, S321: NO, S325: YES), control unit 20 allows the process to proceed to step S326.

An operation by the user for determination as YES in S325 will be described with reference to FIG. 7.

As shown in FIG. 7, as the user orients front camera 8 toward the user himself/herself and performs an operation to cover front camera 8 with his/her hand twice or more within a prescribed time period, an event that the quantity of light in all areas in the image input from front camera 8 varies to a value not greater than the certain value and thereafter exceeds the certain value occurs twice or more within the certain time period, and the process proceeds to step S326.

In step S326, control unit 20 can maintain front camera 8 as the main camera and rear camera 18 as the sub camera and switch the shooting mode to the moving image shooting mode.

In step S327, control unit 20 can have front camera 8 execute face recognition autofocus (AF). Specifically, control unit 20 can detect a position of a face in the image input from front camera 8 and adjust focus of an optical system of front camera 8 such that the detected face is focused on.

In step S328, control unit 20 can have moving images shot with a self-timer function. Specifically, control unit 20 can have storage unit 23 store moving images including an image input from rear camera 18 in the sub image area and including an image input from front camera 8 in the main image area after lapse of 10 seconds.

As set forth above, according to the fifth embodiment, as the user changes how to wave his/her hand or finger in front of the camera set to ON, the camera to be set as the main camera can be maintained, the camera to be set as the main camera can be switched, or the shooting mode can be switched to the operation shooting mode.

### (Modification)

The present disclosure is not limited to the embodiments above, and for example, a modification as below is also encompassed.

### (1) Condition for Switching of Camera

In steps S104 and S117 in FIGS. 11 and 12 in the third embodiment and steps S304 and S317 in FIGS. 18 and 19 in the fifth embodiment, a condition is such that a duration of a condition that a quantity of light in all areas in an image is not greater than a certain value is not shorter than 3 seconds and shorter than 5 seconds, and in steps S108, S121, S308, and S321, a condition is such that a duration of a condition that a quantity of light in all areas in an image is not greater than a certain value is not shorter than 5 seconds and shorter than 8 seconds. Such a condition, however, may be reversed. Specifically, in steps S104, S117, S304, and S317 in FIGS. 11 and 12, a condition may be such that a duration of a condition that a quantity of light in all areas in an image is not greater than a certain value is not shorter than 5 seconds and shorter than 8 seconds, and in steps S108, S121, S308, and S321, a condition may be such that a duration of a condition that a quantity of light in all areas in an image is not greater than a certain value is not shorter than 3 seconds and shorter than 5 seconds.

In steps S204 and S217 in FIGS. 15 and 16 in the fourth embodiment, a condition is such that a duration of a condition that a quantity of light in all areas in an image is not greater than a certain value is not shorter than 3 seconds and shorter than 5 seconds and detection of proximity of an object by a proximity sensor is absent, and in steps S208 and S221, a condition is such that a quantity of light in all areas in an image is not greater than a certain value is not shorter than 3 seconds and shorter than 5 seconds and detection of proximity of an object by a proximity sensor is present. Such a condition, however, may be reversed. Specifically, in steps S204 and S217 in FIGS. 15 and 16, a condition may be such that a duration of a condition that a quantity of light in all areas in an image is not greater than a certain value is not shorter than 3 seconds and shorter than 5 seconds and detection of proximity of an object by a proximity sensor is present, and in steps S208 and S221, a condition may be such that a duration of a condition that a quantity of light in all areas in an image is not greater than a certain value is not shorter than 3 seconds and shorter than 5 seconds and detection of proximity of an object by a proximity sensor is absent.

### (2) Moving Image Shooting Mode

In steps S112 and 125 in FIGS. 11 and 12 in the third embodiment and FIGS. 15 and 16 and in steps S312 and S325 in FIGS. 18 and 19, a condition is such that an event that a quantity of light in all areas in an image input from a camera set to ON or as a main camera varies to a value not greater than a certain value and thereafter exceeds the certain value occurs twice or more within a certain time period (for example, 10 seconds), however, limitation thereto is not intended. Instead of twice, N times (N being a natural number not smaller than 3) may be set as the condition.

### (3) Switching of Main Camera

In steps S304 and S317 in FIGS. 18 and 19 in the fifth embodiment, a condition is such that a duration of a condition that a quantity of light in all areas in an image is not greater than a certain value is not shorter than 3 seconds and shorter than 5 seconds, and in steps S308 and S321, a condition is such that a duration of a condition that a quantity of light in all areas in an image is not greater than a certain value is not shorter than 5 seconds and shorter than 8 seconds. Limitation thereto, however, is not intended.

In steps S304 and S317, a condition may be such that a quantity of light in all areas in an image is not greater than a certain value is not shorter than 3 seconds and shorter than 5 seconds and proximity of an object by a proximity sensor is absent (or present), and in steps S308 and S321, a condition may be such that a quantity of light in all areas in an image is not greater than a certain value is not shorter than 3 seconds and shorter than 5 seconds and proximity of an object by a proximity sensor is present (or absent).

### (4) Gesture

In the third to fifth embodiment, the control unit switches a camera to be set to ON or a camera to be set as main or switches the shooting mode to the moving image shooting mode based on whether or not a condition that a quantity of light in all areas in an image is not greater than a certain value continues or based on the number of times of continuance of such a condition, however, limitation thereto is not intended.

In the third to fifth embodiments as well, the control unit may make switching described above based on a difference in gesture by a user. For example, difference in waving a hand among lateral waving, vertical waving, and diagonal waving may be employed as the difference in gesture, or difference among waving of a thumb, waving of three fingers, and waving of five fingers may be employed as the difference in gesture.

### (5) Main Image and Sub Image

In the fifth embodiment, the user orients the main camera toward the user himself/herself, so that the user himself is shot by the main camera and an image of the user himself/herself is arranged in the main image area large in display region and a background is shot by the sub camera and an image of the background is arranged in the sub image area small in display region. Limitation thereto, however, is not intended.

For example, as shown in FIG. 21, an image from the sub camera may be arranged in the main image area and an image from the main camera may be arranged in the sub image area.

Alternatively, the sub camera may be oriented to the user himself/herself, so that the background is shot by the main camera and an image of the background is arranged in the main image area and the user himself/herself is shot by the sub camera and an image of the user himself/herself is arranged in the sub image area as shown in FIG. 21.

(6) Switching Only Based on Result of Detection by Proximity Sensor without Using Image

In the embodiments above, a camera to be set to ON or a camera to be set as the main camera is switched by detecting whether or not a user covers the camera set to ON or the camera set as the main camera by using an image from the camera or the image from the camera and a result of detection by the proximity sensor, however, limitation thereto is not intended. An image from the camera does not have to be used.

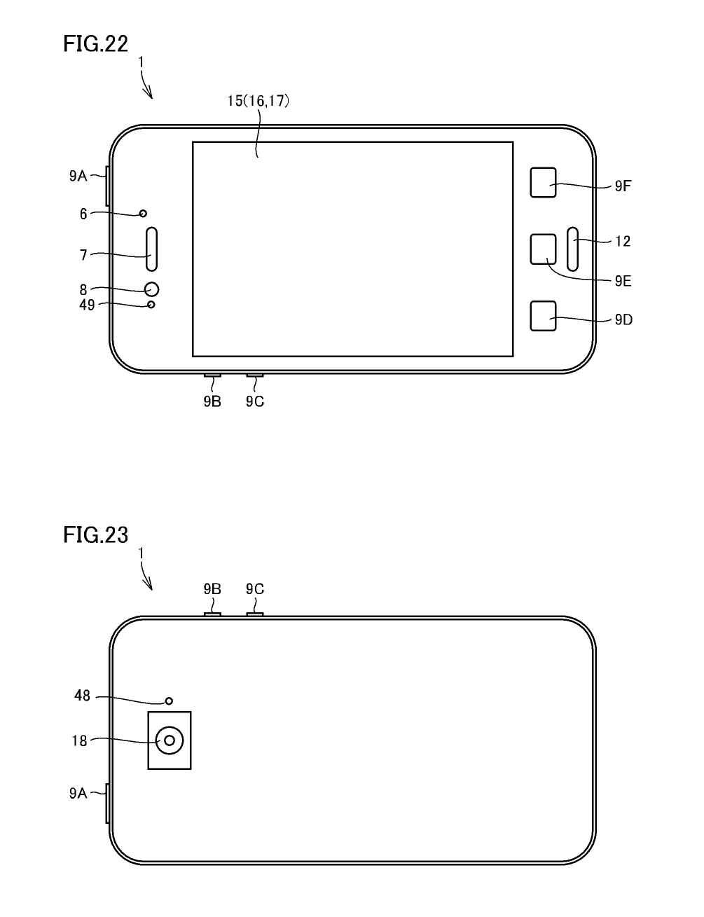

A portable terminal may include a proximity sensor 49 in the vicinity of front camera 8 and a proximity sensor 48 in the vicinity of rear camera 18 (see FIGS. 22 and 23) and the control unit may switch a camera to be set to ON or a camera to be set as the main camera based on whether or not proximity sensor 49 or 48 detects covering by the user of the camera set to ON or the camera set as the main camera.

It should be understood that the embodiments disclosed herein are illustrative and non-restrictive in every respect. The scope of the present disclosure is defined by the terms of the claims and is intended to include any modifications within the scope and meaning equivalent to the terms of the claims.

1. A portable terminal, comprising:
a display unit configured to be located on a front surface of the portable terminal;
a front camera configured to be located on the front surface of the portable terminal;
a rear camera configured to be located on a back surface of the portable terminal;
a storage unit configured to store a control program; and
a processor configured to control the portable terminal by executing the control program,
the processor being configured to set any camera of the front camera and the rear camera to ON and to have the display unit display an image input from the camera set to ON,
the processor being configured to switch the camera to be set to ON when change in condition around the camera set to ON is detected.

2. The portable terminal according to claim 1, wherein:
the processor is configured to switch the camera to be set to ON based on an image input from the camera set to ON.

3. The portable terminal according to claim 2, wherein:
the processor is configured to switch the camera to be set to ON based on whether a quantity of light in all areas in the input image indicates a certain value or lower.

4. The portable terminal according to claim 3, wherein:
the processor is configured to switch the camera to be set to ON from the rear camera to the front camera when a condition that the quantity of light in all areas in the image input from the rear camera is not greater than the certain value continues for a prescribed time period or longer while the rear camera is set to ON.

5. The portable terminal according to claim 3, wherein:
the processor is configured to switch the camera to be set to ON from the rear camera to the front camera when a duration of a condition that the quantity of light in all areas in the image input from the rear camera is not greater than the certain value is within a first prescribed range while the rear camera is set to ON and configured to maintain the rear camera as the camera to be set to ON when the duration of the condition that the quantity of light is not greater than the certain value is within a second prescribed range.

6. The portable terminal according to claim 3, comprising a proximity sensor configured to be located on the front surface of the portable terminal, wherein:
the processor is configured to switch the camera to be set to ON from the rear camera to the front camera or to maintain the rear camera as the camera to be set to ON, based on whether the proximity sensor detects proximity of an object when a duration of a condition that the quantity of light in all areas in the image input from the rear camera is not greater than the certain value is within a prescribed range while the rear camera is set to ON.

7. The portable terminal according to claim 3, wherein:
the processor is configured to switch the camera to be set to ON from the rear camera to the front camera and to switch a shooting mode from a still image shooting mode to a moving image shooting mode when an event that the quantity of light in all areas in the image input from the rear camera varies to a value not greater than the certain value and thereafter exceeds the certain value occurs N or more times within a certain time period while the rear camera is set to ON, with N being a natural number not smaller than 2.

8. The portable terminal according to claim 3, wherein:
the processor is configured to maintain the front camera as the camera to be set to ON when a condition that the quantity of light in all areas in the image input from the front camera is not greater than the certain value continues for a prescribed time period or longer while the front camera is set to ON.

9. The portable terminal according to claim 3, wherein:
the processor is configured to maintain the front camera as the camera to be set to ON when a duration of a condition that the quantity of light in all areas in the image input from the front camera is not greater than the certain value is within a first prescribed range while the front camera is set to ON, and to switch the camera to be set to ON from the front camera to the rear camera when the duration of the condition that the quantity of light is not greater than the certain value is within a second prescribed range.

10. The portable terminal according to claim 3, comprising a proximity sensor configured to be located on the front surface of the portable terminal, wherein:
the processor is configured to switch the camera to be set to ON from the front camera to the rear camera or to maintain the front camera as the camera to be set to ON, based on whether the proximity sensor detects proximity of an object when a duration of a condition that the quantity of light in all areas in the image input from the front camera is not greater than the certain value is within a prescribed range while the front camera is set to ON.

11. The portable terminal according to claim 3, wherein:
the processor is configured to maintain the front camera as the camera to be set to ON and to switch a shooting mode from a still image shooting mode to a moving image shooting mode when the quantity of light in all areas in the image input from the front camera being not greater than the certain value occurs N or more times within a certain time period while the front camera is set to ON, with N being a natural number not smaller than 2.

12. The portable terminal according to claim 4, wherein:
the processor is configured to have a subject shot with the camera to be set to ON with a self-timer function after the camera to be set to ON is switched or maintained.

13. The portable terminal according to claim 12, wherein:
the processor is configured to detect a position of a face in the image and control autofocus based on the detected position of the face before shooting of the subject.

14. The portable terminal according to claim 2, wherein:
the processor is configured to switch the camera to be set to ON based on whether a prescribed gesture is detected in the input image.

15. A portable terminal, comprising:
a display unit configured to be located on a front surface of the portable terminal;
a front camera configured to be located on the front surface of the portable terminal;
a rear camera configured to be located on a back surface of the portable terminal;
a storage unit configured to store a control program; and
a processor configured to control the portable terminal by executing the control program,
the processor being configured to set one camera of the front camera and the rear camera as a main camera, to set the other camera as a sub camera, to have an image input from the main camera displayed in a first region of the display unit, and to have an image input from the sub camera displayed in a second region of the display unit,
the processor being configured to switch a camera to be set as the main camera based on the image input from the camera set as the main camera.
